(19) United States
(12) Patent Application Publication
(10) Pub. No.: US 2009/0110205 A1
(43) Pub. Date: Apr. 30, 2009

(54) Portable Sound System Testing Apparatus

(76) Inventor: James Chris Belt, Indianapolis, IN (US)

Correspondence Address: ADVANTIA LAW GROUP, 9035 SOUTH 1300 EAST, SUITE 200, SANDY, UT, 84094, US

(21) Appl. No.: 11/927,098

(22) Filed: Oct. 29, 2007

(51) Int. Cl. H04R 29/00

(52) U.S. Cl. 381/58

(57) ABSTRACT

A portable sound system testing apparatus at least includes: an AC power module adapted to provide connected AC power to the apparatus; a power switch module adapted to switch power to the apparatus ON and OFF; an AC-to-DC conversion module adapted to convert AC power received into DC power suitable for powering a sound system to be tested; a power and ground module coupled to the AC to DC conversion module, and at least including a power out terminal for outputting DC power to the sound system to be tested, and a ground terminal for connecting the sound system to be tested to ground; a testing antenna; an antenna lead module coupled to the testing antenna and adapted to be coupled to the antenna of the sound system to be tested; a speaker terminal module at least including speaker terminals adapted to be connected to loudspeaker connectors of the sound system to be tested; a sound reproduction module coupled to the speaker terminal module, adapted to reproduce audio signals received from the sound system to be tested; and a control module coupled to the power and ground module, coupled to the speaker terminal module, and coupled to the sound reproduction module, the control module adapted to control the operation of the apparatus.

### BACKGROUND OF THE INVENTION

1. Field of the Invention

The present invention generally relates to testing equipment, and specifically relates to sound system testing equipment.

2. Description of the Related Art

Automotive stereo systems are often tedious and time-consuming to install and remove due to space constraints and other limitations of the target automobile. Given the effort to install such sound systems, it is discouraging when one discovers, post installation, that a particular sound system is defective. Not only are used sound systems sometimes defective, but new sound systems are sometimes also defective.

There is a need to effectively test automotive sound systems prior to installation. The prior art has not adequately addressed the problem. For example, U.S. Pat. No. 4,110,571 issued to Hills appears to be limited to testing loudspeakers and loudspeaker wires only, and not for testing whether an overall sound system is properly functioning. Still other prior art apparatuses such as disclosed in U.S. Pat. No. 4,604,064 issued to Boehm et al., while for connecting to electronic equipment, are large, complicated apparatuses that are for training and demonstration purposes, and not appropriate for bench testing of automotive stereo systems prior to installation.

Yet other prior art approaches, such as the ones disclosed in U.S. Pat. Nos. 5,361,305 (issued to Easley et al.) and 6,501,277 (issued to Sybesma), use testers for analyzing automotive audio systems only after installation.

What is therefore needed, but lacking in the prior art, is a simple, self-contained, portable sound system testing apparatus for conveniently and effectively testing whether an automotive sound system is operational, prior to installation of the system.

### SUMMARY OF THE INVENTION

The present invention has been developed in response to the present state of the art, and in particular, in response to the problems and needs in the art that have not yet been fully solved by currently available apparatuses. Accordingly, the present invention has been developed to provide an improved portable sound system testing apparatus.

In one embodiment of the invention, the portable sound system testing apparatus at least includes: an AC power module adapted to provide connected AC power to the apparatus; a power switch module adapted to switch power to the apparatus ON and OFF; an AC-to-DC conversion module adapted to convert AC power received into DC power suitable for powering a sound system to be tested; a power and ground module coupled to the AC to DC conversion module, and at least including a power out terminal for outputting DC power to the sound system to be tested, and a ground terminal for connecting the sound system to be tested to ground; a testing antenna; an antenna lead module coupled to the testing antenna and adapted to be coupled to the antenna of the sound system to be tested; a speaker terminal module at least including speaker terminals adapted to be connected to loudspeaker connectors of the sound system to be tested; a sound reproduction module coupled to the speaker terminal module, adapted to reproduce audio signals received from the sound system to be tested; and a control module coupled to the power and ground module, coupled to the speaker terminal module, and coupled to the sound reproduction module, the control module adapted to control the operation of the apparatus.

In another embodiment of the invention, the portable sound system testing apparatus further at least includes a display module for displaying testing information.

In yet another embodiment of the invention, the power output terminal and the ground terminal are of the spring-loaded, push-in variety.

In a further embodiment of the invention, the speaker terminals are of the spring-loaded, push-in variety.

In yet a further embodiment of the invention, the portable sound system testing apparatus further at least includes a power indicator module adapted to indicate whether the apparatus is ON or OFF.

In still yet another embodiment of the invention, the portable sound system testing apparatus further at least includes a display module for displaying testing information; and a power indicator module adapted to indicate whether the apparatus is ON or OFF; wherein the power output terminal and the ground terminal are of the spring-loaded, push-in variety, and wherein the speaker terminals are of the spring-loaded, push-in variety.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates the rear view of an embodiment of the present-inventive portable sound system testing apparatus;

FIG. 2 illustrates the front view of an embodiment of the present-inventive portable sound system testing apparatus; and

FIG. 3 illustrates a block diagram of an embodiment of the present-inventive portable sound system testing apparatus.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

As used herein, “comprising,” “including,” “containing,” “is”, “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

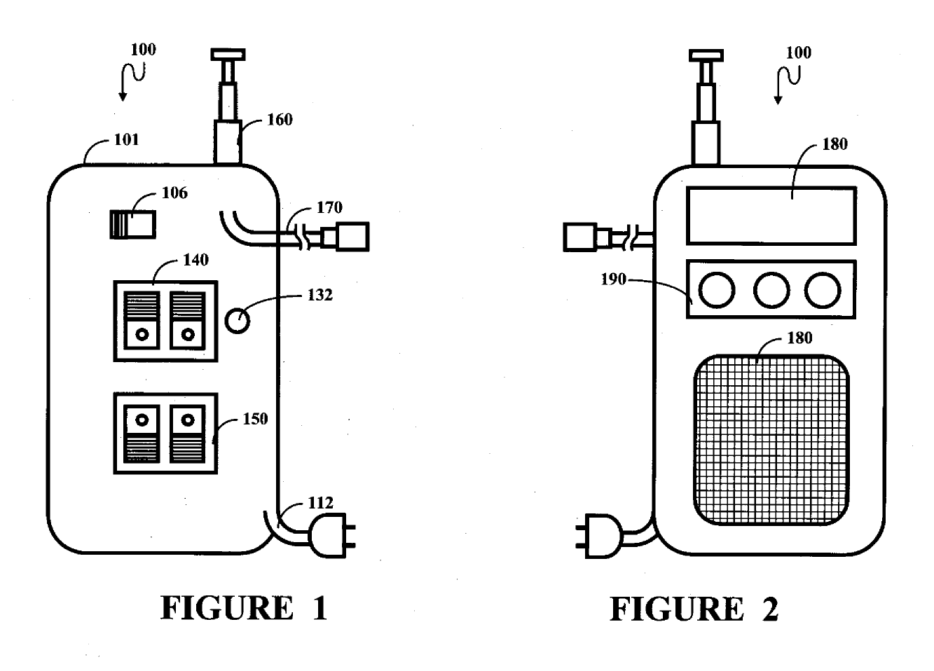

An exemplary embodiment of the present-inventive portable sound system testing apparatus 100 is illustrated in FIGS. 1 through 3. The testing apparatus 100 is used to test a target audio/sound system by supplying both DC power (e.g., 12 volts) to the target system, as well supplying an antenna signal. Additionally, one or more loudspeakers of the testing apparatus are connected to audio output jacks or wiring of the target sound system. In this manner, one can use the testing apparatus 100 to determine whether the target sound system is functioning prior to installing it in an automobile (i.e., without having to connect the target sound system to the actual automobile speakers, and without having to connect the target sound system to the actual automobile power source). All of the components are separately commercially available, as will be appreciated by those skilled in the art to which the present invention pertains.

In FIG. 1, the rear view of an embodiment of the testing apparatus 100 is shown. A housing 101 contains the components of the testing apparatus. A power switch 106 is used to turn the testing apparatus 100 “on” or “off.” AC power is supplied from a conventional power outlet via a power input cord 112 to the testing apparatus 100. A power indicator light 132 illuminates when the testing apparatus 100 is turned on. The knobs of a control module 190 (as first seen in FIG. 2) are used to control the operation of the testing apparatus 100. Information regarding testing and the operation of the testing apparatus are displayed via a display module 196 (also first seen in FIG. 2).

In one embodiment of the present invention the control module 190 includes a microprocessor, as is well known in the art. Those skilled in the art will appreciate that other electronic apparatuses such as state machines, to name just one, can be used to control the operation of the testing apparatus 100.

The front view of the testing apparatus 100 shown in FIG. 2 also shows a sound reproduction/speaker module 180 which includes one or more loudspeakers. Returning to FIG. 1, a power and ground module 140 has spring-loaded, push-in terminals to supply power via a power terminal to the target sound system, and a ground terminal to connect the target sound system to ground. Those skilled in the art will appreciate that a variety of terminal types can be used to connect between the testing apparatus and the target sound system. Further, in one embodiment of the present-inventive testing apparatus, the connecting wires have alligator clips on the ends which are to be connected directly to the target sound system, although other suitable connectors can be used.

Wires from the audio output jacks of the target sound system are connected to a speaker terminal module 150. The speaker terminal module 150 is connected to the sound reproduction module 180, where any audio signal received is converted to sound. A broadcast signal can be received by an antenna 160 and connected to the antenna lead of the target sound system via an antenna lead module 170.

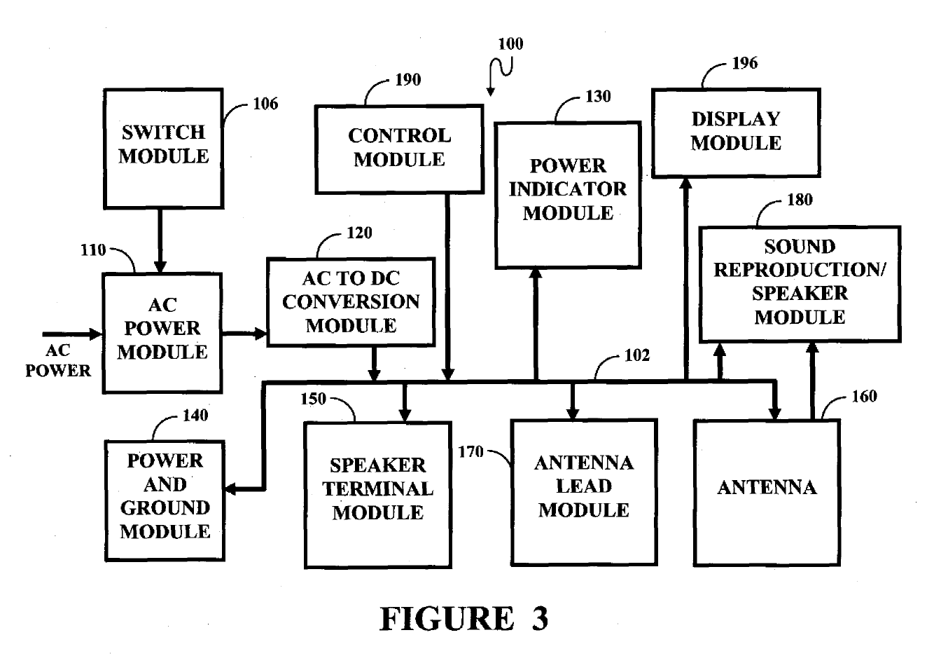

Turning to FIG. 3, a block diagram illustrates the major components of an embodiment of the present-inventive portable sound system testing apparatus 100. In the example shown, a bus 102 electrically connects the apparatus components. The power switch module 106 activates the AC power module 110, which receives AC power. The power switch module 106 also activates the control module 190. An AC-to-DC conversion module 120 converts AC power to DC power, which DC power is supplied to the target sound system, as well as to the components of the testing apparatus. Also, a power indicator module 130 activates the aforementioned power indicator light 132 when the testing apparatus is turned on.

The power and ground module 140 connects power and ground terminals to the target sound system as previously described. Any audio output signals from the target sound system are received by the speaker terminal module 150 and reproduced by the speakers of the sound reproduction/speaker module 180. And, broadcast signals received from the antenna 160 are transmitted to the antenna input jack of the target sound system via an antenna lead module 170.

Information regarding the operation of the test apparatus 100, as well as test information from the target sound system is displayed by the display module 196.

In operation of the illustrated apparatus, users can bench-test a target sound system by simulating post-installation conditions. In particular, the testing apparatus 100 is used to determine: whether the target sound system responds to input DC power; whether the target sound system can receive and process an antenna signal, and whether a target sound system can output a reproducible audio signal. To summarize, the user connects the power and ground module terminals 140 via wires or cables, to power and ground jacks of the target sound system, followed by connecting the audio output jacks of the target sound system via wires or cable to the terminals of the speaker terminal module 150. The user also connects the antenna lead module 170 to the antenna input lead of the target sound system. Finally, the user turns on the testing apparatus 100 with the switch 106, and controls the operation of the testing apparatus at the control module 190. Such control includes the ability to tune the testing apparatus to a radio station via an enclosed tuner. A properly functioning target sound system will cause an appropriate audio output through the sound reproduction/speaker module 180.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

It is expected that there could be numerous variations of the design of this invention. It is also envisioned that the components of the device may be constructed of a variety of materials.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A portable sound system testing apparatus comprising:
an AC power module adapted to provide connected AC power to said apparatus;
a power switch module adapted to switch power to said apparatus ON and OFF;
an AC-to-DC conversion module adapted to convert AC power received into DC power suitable for powering a sound system to be tested;
a power and ground module coupled to said AC to DC conversion module, and comprising a power out terminal for outputting DC power to the sound system to be tested, and a ground terminal for connecting the sound system to be tested to ground;
a testing antenna;
an antenna lead module coupled to said testing antenna and adapted to be coupled to the antenna of the sound system to be tested;
a speaker terminal module comprising speaker terminals adapted to be connected to loudspeaker connectors of the sound system to be tested;
a sound reproduction module coupled to said speaker terminal module, adapted to reproduce audio signals received from the sound system to be tested; and
a control module coupled to said power and ground module, coupled to said speaker terminal module, and coupled to said sound reproduction module, said control module adapted to control the operation of said apparatus.

2. The portable sound system testing apparatus of claim 1, further comprising a display module for displaying testing information.

3. The portable sound system testing apparatus of claim 1, wherein said power output terminal and said ground terminal are of the spring-loaded, push-in variety.

4. The portable sound system testing apparatus of claim 1, wherein said speaker terminals are of the spring-loaded, push-in variety.

5. The portable sound system testing apparatus of claim 1, further comprising a power indicator module adapted to indicate whether said apparatus is ON or OFF.

6. The portable sound system testing apparatus of claim 1, further comprising a display module for displaying testing information; and
a power indicator module adapted to indicate whether said apparatus is ON or OFF;
wherein said power output terminal and said ground terminal are of the spring-loaded, push-in variety, and wherein said speaker terminals are of the spring-loaded, push-in variety.

7. A portable sound system testing apparatus consisting essentially of:
an AC power module adapted to provide connected AC power to said apparatus;
a power switch module adapted to switch power to said apparatus ON and OFF;
an AC-to-DC conversion module adapted to convert AC power received into DC power suitable for powering a sound system to be tested;
a power and ground module coupled to said AC to DC conversion module, and consisting essentially of a power out terminal for outputting DC power to the sound system to be tested, and a ground terminal for connecting the sound system to be tested to ground;
a testing antenna;
an antenna lead module coupled to said testing antenna and adapted to be coupled to the antenna of the sound system to be tested;
a speaker terminal module consisting essentially of speaker terminals adapted to be connected to loudspeaker connectors of the sound system to be tested;
a sound reproduction module coupled to said speaker terminal module, adapted to reproduce audio signals received from the sound system to be tested; and
a control module coupled to said power and ground module, coupled to said speaker terminal module, and coupled to said sound reproduction module, said control module adapted to control the operation of said apparatus.

8. A portable sound system testing apparatus consisting of:
an AC power module adapted to provide connected AC power to said apparatus;
a power switch module adapted to switch power to said apparatus ON and OFF;
an AC-to-DC conversion module adapted to convert AC power received into DC power suitable for powering a sound system to be tested;
a power and ground module coupled to said AC to DC conversion module, and consisting of a power out terminal for outputting DC power to the sound system to be tested, and a ground terminal for connecting the sound system to be tested to ground;
a testing antenna;
an antenna lead module coupled to said testing antenna and adapted to be coupled to the antenna of the sound system to be tested;
a speaker terminal module consisting of speaker terminals adapted to be connected to loudspeaker connectors of the sound system to be tested;
a sound reproduction module coupled to said speaker terminal module, adapted to reproduce audio signals received from the sound system to be tested; and
a control module coupled to said power and ground module, coupled to said speaker terminal module, and coupled to said sound reproduction module, said control module adapted to control the operation of said apparatus.
